(19) United States
(12) Patent Application Publication
(10) Pub. No.: US 2009/0265394 A1
(43) Pub. Date: Oct. 22, 2009

(54) File Storing Method, File Storage System, and Computer Readable Recording Medium Stored with Computer Program Executable on Master File Combination Device

(75) Inventor: Kazuhiko Tsujiwaki, Nishinomiya-shi (JP)

Correspondence Address: SQUIRE, SANDERS & DEMPSEY L.L.P., 1 MARITIME PLAZA, SUITE 300, SAN FRANCISCO, CA, 94111, US

(73) Assignee: Konica Minolta Business technologies, Inc., Tokyo (JP)

(21) Appl. No.: 12/406,895

(22) Filed: Mar. 18, 2009

(30) Foreign Application Priority Data
Mar. 28, 2008 (JP) 2008-085924

(51) Int. Cl. G06F 12/00; G06F 17/30

(52) U.S. Cl. 707/203; 707/205; 709/206; 707/E17.01; 707/E17.032

(57) ABSTRACT

A coordinated application server acquires a specific file and an additional information concerning the specific file to be stored, identifies type information that indicates a type of contents of the specific file from the additional information, and makes a judgment as to whether or not a master file corresponding to the type information exists in a file server. Then, if such a master file exists, the coordinated application server combines the specific file to the maser file and adds identification information, for identifying the specific file, identified from the additional information to the master file as reference information for referencing the specific file in the master file.

### CROSS-REFERENCE TO RELATED APPLICATION

This application is based on Japanese Patent Application No. 2008-085924 filed on Mar. 28, 2008, the contents of which are incorporated herein by reference.

### BACKGROUND

1. Technical Field

The present invention relates to a file storing method, a file storage system, and a computer readable recording medium stored with a computer program executable on a master file combination device.

2. Description of Related Art

A system has been proposed for storing files of image data acquired by using devices such as MFP (Multi-Function Peripheral) and others having a scanning function for scanning document images into a server and for notifying URL (Uniform Resource Locater) of the point where the files are stored to users who need such files bye-mail. See Unexamined Japanese Patent Publication No. 2005-173839.

Upon receiving such a notice in the above-mentioned system, a user can review the files stored in the server referencing the URL of the point where the files are stored.

However, since a plurality of files are stored individually in the server, there was a problem that it is difficult to identify what kind of contents are stored in which file. In other words, there was an inconvenience such that, in order to review the files stored in the past, it was necessary to search the notification mail which contains the storage location information and then open each file one by one to check the contents of each file referencing the storage location information.

### SUMMARY

It is an object of the present invention to provide a file storing method, a file storage system, and a computer readable recording medium stored with a computer program executable on a master file combination device, all of which are improved to solve at least one of the above-mentioned problems.

Another object of the present invention is to provide a file storing method, a file storage system, and a computer readable recording medium stored with a computer program executable on a master file combination device that make it easier to grasp the contents of stored file to improve accessibility.

To achieve at least one of the abovementioned objects, a file storing method reflecting one aspect of the present invention comprises: (a) a master file combination device acquiring a specific file to be stored and additional information concerning the specific file; (b) said master file combination device identifying type information that indicates a type of contents of said specific file from said additional information; (c) said master file combination device judging whether or not a master file that corresponds to said type information exists in a master file storage device; and (d) said master file combination device combining said specific file with said master file and adding identification information, for identifying said specific file, identified from said additional information to said master file as reference information for referencing said specific file in said master file, if it is judged that a master file that corresponds to said type information exists.

In the abovementioned file storing method, it is preferable that the file storing method further comprises: (e) said master file combination device transmitting notification mail containing storage location information for designating storage place of said master file with which said specific file is combined to a designated destination.

In the abovementioned file storing method, it is preferable that the file storing method further comprises: (f) a file transmission device generating a specific file to be generated; (g) said file transmission device generating additional information concerning said specific file; and (h) said file transmission device transmitting said specific file and said additional information in order to cause said specific file and said additional information to be stored in a specific file storage device, wherein in said step (a), said master file combination device acquires said specific file and said additional information from said specific file storage device.

In the abovementioned file storing method, it is preferable that, in said step (c), said master file combination device makes a judgment as to whether or not type information that indicates the type of contents of said specific file exists in a type information list where type information is stored for indicating a type of the contents of each master file stored in said master file storage device.

In the abovementioned file storing method, it is preferable that said master file is a PDF file and said reference information is bookmark information designated in the PDF file.

In the abovementioned file storing method, it is preferable that, in said step (d), if said master file's data size exceeds a specified upper limit when said specific file is combined with said master file, said master file combination device treats said specific file as the second master file that is equivalent to a continuation of said master file, and adds identification information, for identifying said specific file, identified from said additional information to said second master file as reference information for referencing said specific file in said second master file.

In the abovementioned file storing method, it is preferable that, in said step (d), if the number of combinations with said master file exceeds a specified upper limit when said specific file is combined with said master file, said master file combination device treats said specific file as the second master file that is equivalent to a continuation of said master file, and adds identification information, for identifying said specific file, identified from said additional information to said second master file as reference information for referencing said specific file in said second master file.

In the abovementioned file storing method, it is preferable that, in said step (d), if the user's instruction not to combine said specific file with said mater file already exists in said additional information, said master file combination device treats said specific file as the second master file that is equivalent to a continuation of said master file, and adds identification information for identifying said specific file identified from said additional information to said second master file as reference information for referencing said specific file in said second master file.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a diagram showing the overall constitution of a file storage system according to the first embodiment of the present invention.

FIG. 2 is a block diagram showing the hardware constitution of an MFP.

FIG. 3 is a block diagram showing the hardware constitution of the coordinated application server.

FIG. 4 is a block diagram showing the hardware constitution of a FTP server.

FIG. 5 is a block diagram showing the hardware constitution of the user's PC.

FIG. 6 is a functional block diagram showing the software constitution of the file storage system according to the embodiment.

FIG. 7 is a sequence chart showing the display control of a screen of the operating panel of the MFP via communication with the coordinated application server.

FIG. 8 is a diagram showing an example of the additional information designating screen.

FIG. 9 is a diagram showing an example of the destination group selection screen.

FIG. 10 shows an example of the destination name management table.

FIG. 11 is a diagram showing an example of the additional information file.

FIG. 12 is a flowchart showing the procedure of data transmission process of specific files and additional information on the MFP.

FIG. 13 is a flow chart showing the procedure of file storage process on the coordinated application server.

FIG. 14 is a diagram showing an example of the master file management table.

FIG. 15 is a flowchart showing the sequence of the master file existence judgment process.

FIG. 16 is a flowchart showing the sequence of the master file combination process.

FIG. 17 is a diagram showing an example of the master file prior to the combining of a specific file.

FIG. 18 is a diagram showing an example of the master file after the combination of a specific file.

FIG. 19 shows an example of bookmark information.

FIG. 20 is a diagram showing an example of bookmark information after new bookmark information is added.

FIG. 21 is a diagram showing an example of “bookmark” for displaying the master file prior to adding new bookmark information.

FIG. 22 is a diagram showing an example of “bookmark” for displaying the master file after adding new bookmark information.

FIG. 23 is a flowchart showing the sequence of the master file new generation process.

FIG. 24 is a flowchart showing the sequence of the transmission process for the notification mail.

FIG. 25 shows an example of the destination management table.

FIG. 26 is a diagram showing an example of the user information management table.

FIG. 27 is a flowchart showing the process sequence of the master file combination process according to the second embodiment of the invention.

FIG. 28 is a flowchart showing the process sequence of the master file combination process according to the third embodiment of the invention.

FIG. 29 is an example of the additional information designating screen according to the fourth embodiment.

FIG. 30 is an example of the additional information file according to the fourth embodiment.

FIG. 31 is a flowchart showing the process sequence of the master file combination process according to the fourth embodiment of the invention.

### DETAILED DESCRIPTION

The preferred embodiments of the invention will be described in detail below with reference to the accompanying drawings.

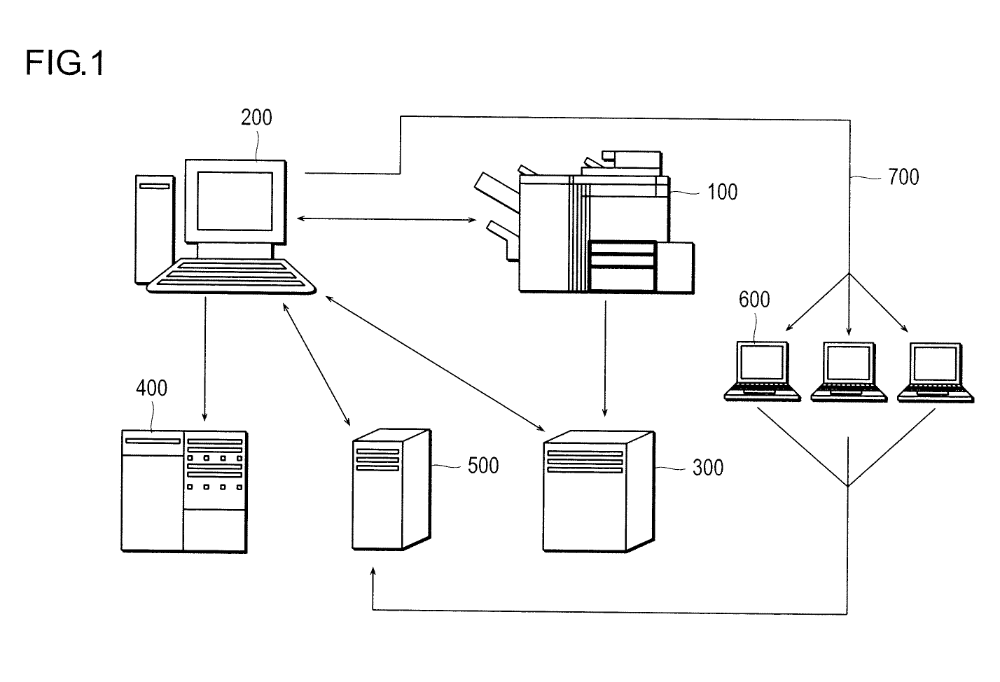

FIG. 1 is a diagram showing the overall constitution of a file storage system according to a first embodiment of the present invention.

The file storage system has an MFP (corresponds to a file transmission device) 100, which has a scanning function for scanning document images and serves as a device to be operated by the user during operation of the system, a coordinated application server (corresponds to the master file linking device) 200, which conducts major processes such as coordination with the MFP 100 and combination of files, an FTP (File Transfer Protocol) server (corresponds to specific file storage device) 300, which serves as the destination of files of image data acquired by scanning document images by the MFP 100, a database server 400, which stores information for managing various kinds of data such as the master file, a file server (corresponds to the master file storage device) 500 for storing the master file, and a user PC 600, which serves as a browsing terminal of the master file. The term “file” is used in this specification to mean a unit for handling a group of data.

These devices, i.e., MFP 100, coordinated application server 200, FTP server 300, database server 400, file server 500, and user PC 600 are mutually connected to allow communications among them via a network 700, e.g., Ethernet®. However, they can also be directly connected between them as local connections.

Next, the constitution of each device will be described and it is noted here that each of those devices can include constituents other than those to be described later or can include only a part of the constituents to be described later. Also, the description of a function common to multiple devices will be made only once when it appears first time and will not be repeated afterwards in order to avoid duplicate descriptions.

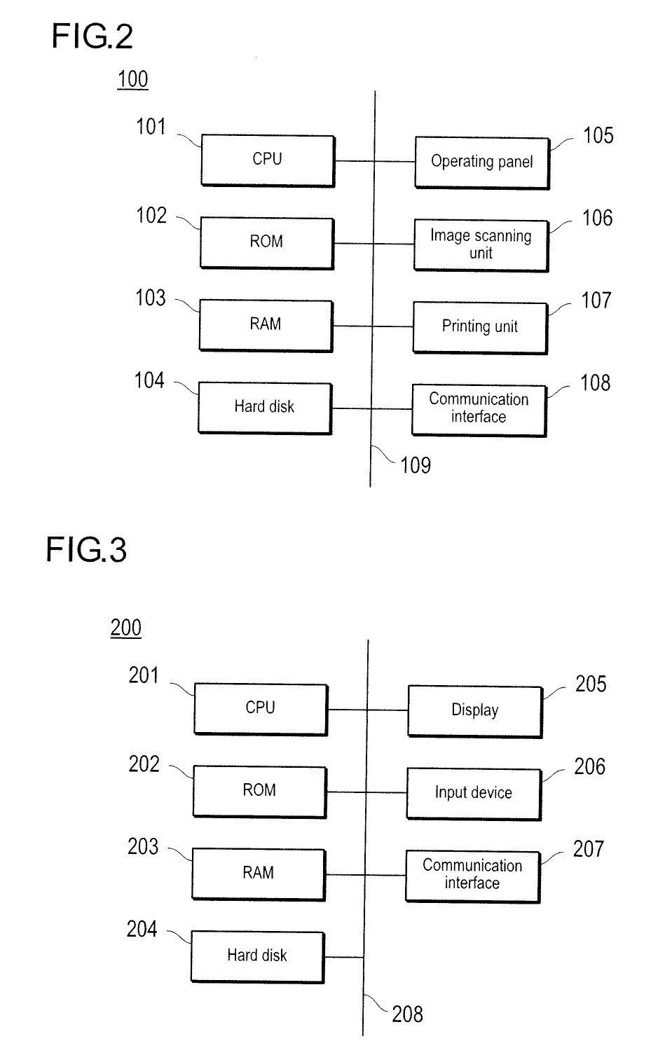

FIG. 2 is a block diagram showing the hardware constitution of the MFP 100. The MFP 100 is equipped with a CPU 101, a ROM 102, a RAM 103, a hard disk 104, an operating panel 105, a printing unit 107, and a communication interface 108, all of which are interconnected with each other via a bus 109 for exchanging signals.

The CPU 101 controls various parts indicated above and executes various arithmetic processes according to a program. The ROM 102 stores various programs and data. The RAM 103 stores programs and data temporarily as a working area. The hard disk 104 stores various programs including an operating system and data.

The operating panel 105 consists of a touch panel as well as fixed keys and indicator lamps and others provided outside of the touch panel used for various inputting and displaying purposes. The image scanning unit 106 irradiates a document set on the scanning position on a document table or transported to the specified scanning location by the ADF (Auto Document Feeder) with a light source such as a fluorescent lamp and the like, converts reflected lights from the document surface into electrical signals with the help of light sensitive devices such as CCD, and generates image data from the electrical signals. The printing unit 107 prints imaged on recording media such as printing paper by printing means such as electronic photography means. The communication interface 108 is an interface for communicating with other equipment.

Because of the abovementioned constitutions, MFP 100 has all of the functions as a scanner for scanning the document and transmitting image data to external equipment, as a printer for printing images based on the image data received from external equipment, as a copying machine for scanning the document image and printing the image data, and as a facsimile machine for receiving and transmitting image data through telephone circuits.

FIG. 3 is a block diagram showing the hardware constitution of a coordinated application server 200. The coordinated application server 200 is provided with a CPU 201, a ROM 202, a RAM 203, a hard disk 204, a display 205, an input device 206 and a communication interface 207, all of which are interconnected by a bus 208 for exchanging signals.

The display 205 displays various kinds of information. The input device 206 includes a pointing device such as a mouse, a keyboard, and others, and is used for executing various kinds of inputs.

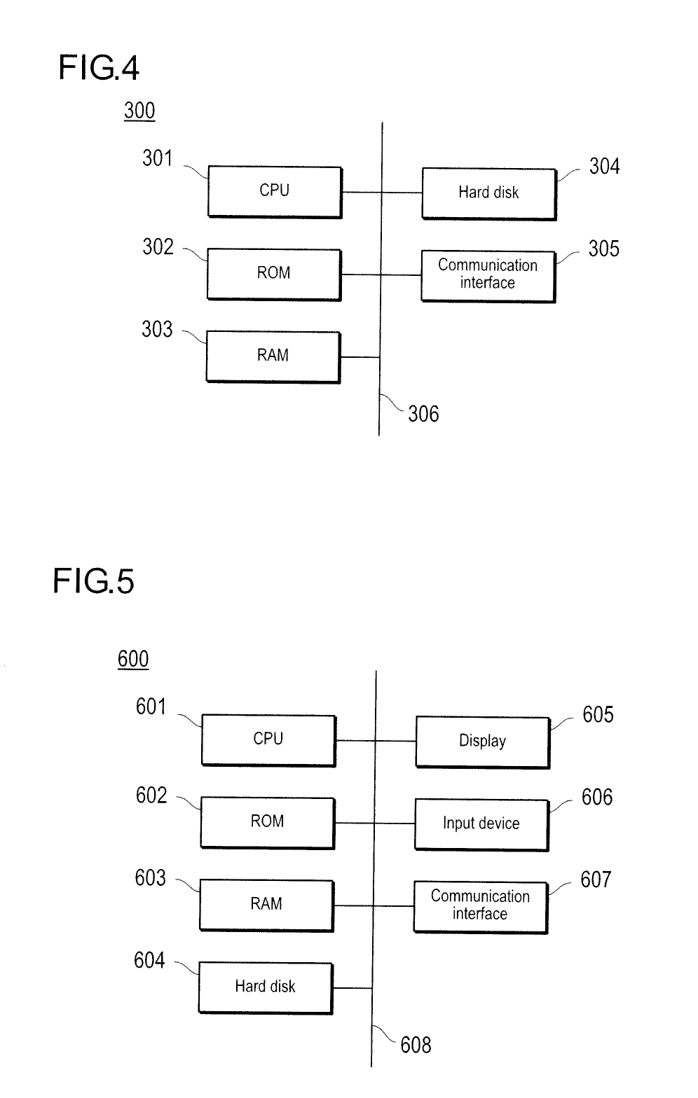

FIG. 4 is a block diagram showing the hardware constitution of a FTP server 300. The FTP server 300 is provided with a CPU 301, a ROM 302, a RAM 303, a hard disk 304, and a communication interface 305, all of which are interconnected via a bus 308 for exchanging signals.

The hardware constitutions of the database server 400 and the file server 500 are identical to those of the FTP server 300, so that their descriptions are skipped.

FIG. 5 is a block diagram showing the hardware constitution of the user's PC 600. The user's PC 600 is provided with a CPU 601, a ROM 602, a RAM 603, a hard disk 604, a display 605, an input device 606 and a communication interface 607, all of which are interconnected by a bus 608 for exchanging signals.

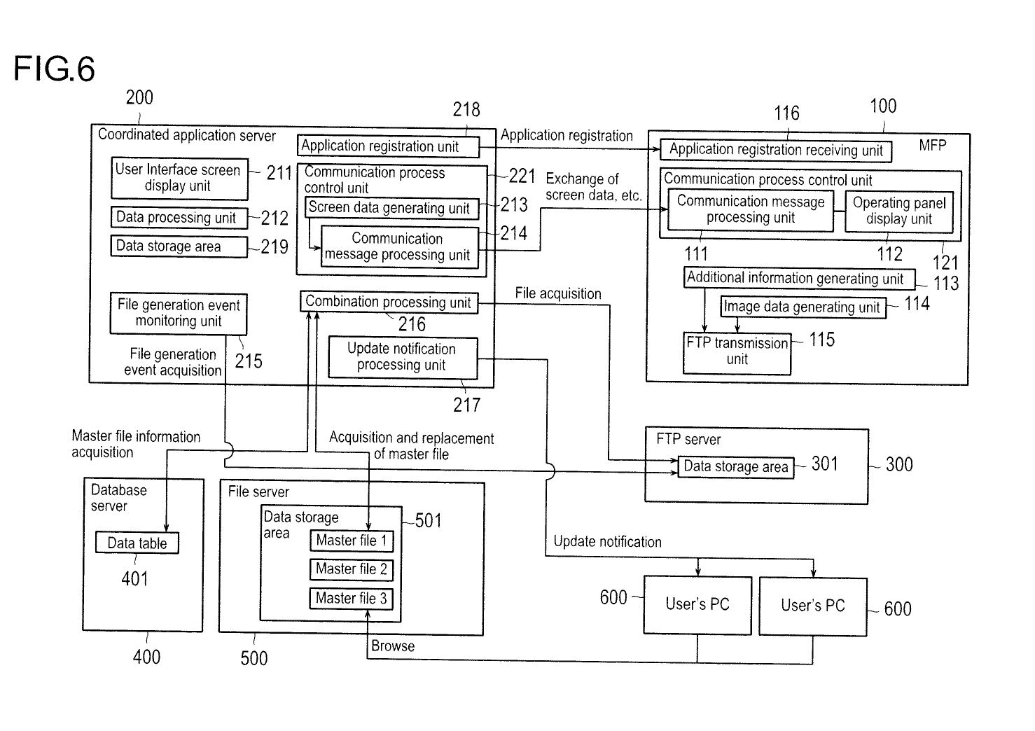

FIG. 6 is a functional block diagram showing the software constitution of the file storage system according to the embodiment.

To provide an application function in coordination with MFP 100, the coordinated application server 200 is provided with a user interface image display unit 211, a data processing unit 212, image data generating unit 213, and a communication message unit 214.

The user interface image display unit 211 causes the display 205 to display images. The data processing unit 212 processes data necessary for coordination with MFP 100. The communication message processing unit 214 handles image data generated by the image data generating unit 213. The coordinated application server 200 has a data storage area 219. The data storage area 219 is allocated to storage units such as the hard disk 204.

The coordinated application server 200 has a file generating event monitoring unit 215, a combination processing unit 216, and an update notification processing unit 217. The coordinated application server 200 has an application registration unit 218 for registering MFP side applications in the MFP 100.

The functions of the abovementioned various units of the coordinated application server 200 are activated when the programs stored in storage units such as hard disk 204 are retrieved onto the RAM 203 and executed.

The MFP 100 is equipped with a communication message processing unit 111 that controls communication processes with the PC and an operating panel 112. The MFP 100 is equipped with an additional information generating unit 113, an image data generating unit 114, and an FTP transmitting unit 115. The MFP 100 is further equipped with an application registration receiving unit 116 for receiving registration requests for the MFP side application from the coordinated application server 200. The functions of the above-mentioned various units of the MFP 100 are activated when the programs stored in storage units such as hard disk 104 are retrieved onto the RAM 103 and executed.

The FTP server 300 is equipped with a data storage area 301 and the file server 500 is equipped with a data storage area 501. The database server 400 is equipped with a data table 401 that manages various data. The data storage area 301, the data storage area 501, and the data table 401 are allocated to various storage units such as the hard disk of each device.

As a preparation, the MFP side applications are registered to the MFP 100 by the application registration unit 218 of the coordinated application server 200.

In registering the MFP side applications to the MFP 100, there are two kinds of registration types, i.e., static and dynamic types. In registering the MFP applications to the MFP 100, the static type allows the data (image data) of the additional information designating screen, which is necessary for the user operation to be displayed on the operating panel 105 of the MFP 100, to be registered to the MFP 100. In this case, it is not necessary to exchange the image data between the MFP 100 and the coordinated application server 200 for the user's operation on the operating panel 105. On the other hand, the dynamic type does not require registration of the image data when registering the MFP side applications to the MFP 100, and the image data are exchanged dynamically between the MFP 100 and the coordinated application server 200 as the user operates on the operating panel 105. The present embodiment uses the dynamic type.

When the user starts to operate the operating panel 105 of the MFP 100, exchanges of image data and other data start between the communication process control unit 221 of the coordination application server 200 and the communication process control unit 121 of the MFP 100. Next, when the user performs document image scanning (scanning of documents) using the image scanning unit 106, an image data file acquired by scanning the document image by the image data generating unit 114 of the MFP 100 is generated as a specific file to be saved. The items that the user designated on the additional information designating screen to be displayed on the operating panel 105 are generated as additional information by the additional information generating unit 113. The specific files and additional information are then transmitted to the FTP server 300 via the FTP transmission unit 115 and stored in the specified directories in the data storage area 301.

The file generation event monitoring unit 215 of the coordination application server 200 monitors the specified directory in the data storage area 301 of the FTP server 300. The file generation event monitoring unit 215 detects that a specific file or additional information is generated in the directories in the FTP server 300 it is monitoring, the combination processing unit 216 of the coordinated application server 200 acquires the abovementioned specific file and additional information from the FTP server 300.

The combination processing unit 216 of the coordinated application server 200 identifies type information that represents the type of contents of the specific files in the additional information, and acquires necessary data from the data table 401 of the database server 400 in order to identify the master file corresponding to the particular type information. The combination process unit 216 acquires the master file from the file server 500 based on the data acquired from the data table 401. The database stored in the database server 400 can be replaced with a file containing the data contents in the XML (Extensible Markup Language) type and others, if it is an operating environment of a small scale management data.

The combination processing unit 216 combines the master file with the specific file acquired by scanning the document image this time, adds to the master file the identification information for identifying the specific file identified from the additional information as the reference information for referencing the specific file in the master file.

The master file in the present embodiment is a PDF (Portable Document Format) file, and the reference information is the bookmark information to be designated in the PDF file. The combination of the specific file to the master file and the embedding of the bookmark information can be implemented using publicly known technology as the PDF file format is in the public domain.

The combination processing unit 216 of the coordinated application server 200 stores the updated master file by replacing it with the specified directory in the data storage area 501 of the file server 500. Also, the combination processing unit 216 updates the master file management table, which is one of the data tables 401 of the database server 400. Next, the update notification processing unit 217 of the coordinated application server 200 transmits notification mail that includes the storage location information indicating the storage place of the master file to which the specific file is combined. Upon receiving the notification mail, the user becomes cable of browsing the master file stored in the file server 500 from the PC 600.

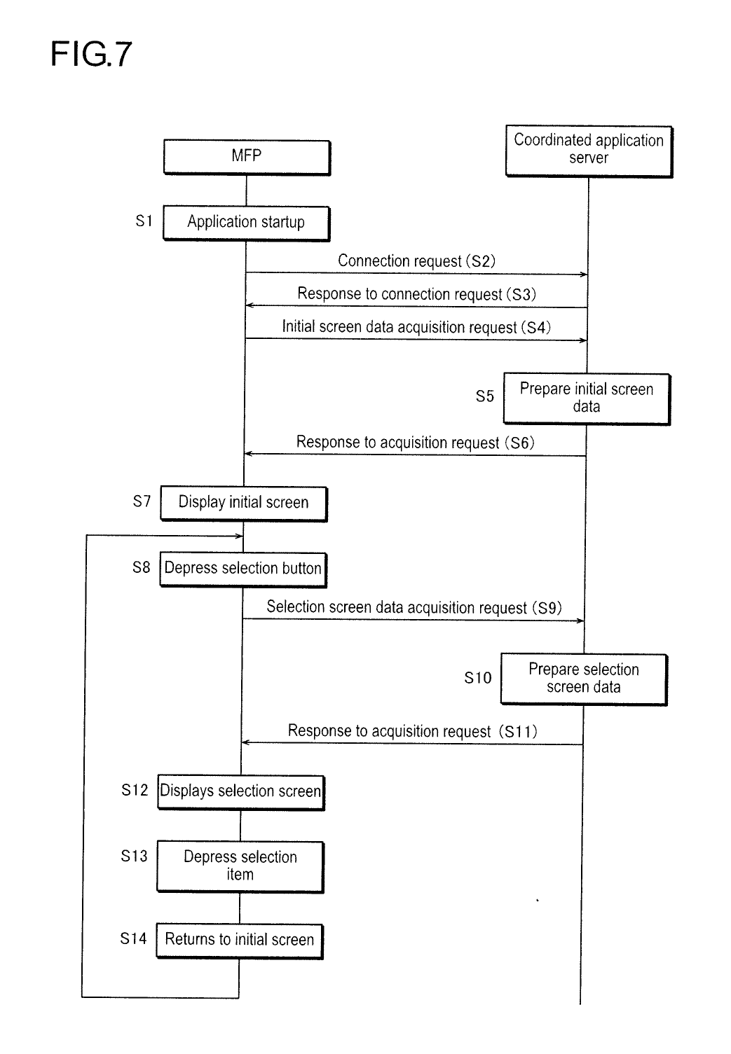

FIG. 7 is a sequence chart showing the display control of a screen of an operating panel of an MFP via communication with the coordinated application server.

As the MFP side application inside the MFP 100 is activated by the user's operation (S1), the MFP 100 transmits a connection request to the coordinated application server 200 (S2). Upon receiving a response to the connection request from the coordinated application server 200 (S3), the MFP 100 transmits an initial screen data request to the coordinated application server 200 in order to acquire the initial screen data, which is the data for the added information setup screen to be displayed on the operating panel 105 (S4). Next, the coordinated application server 200 prepares the initial screen data included in the coordinated application (S5). The coordinated application server 200 may acquire the initial screen data by inquiring external database, etc. The coordinated screen server 200 provides a response to the initial screen data request to the MFP 100 (S6). In other words, the coordinated application server 200 transmits the initial screen data to the MFP 100. The MFP 100 displays the additional information designating screen on the operating panel 105 based on the received initial screen data (S7).

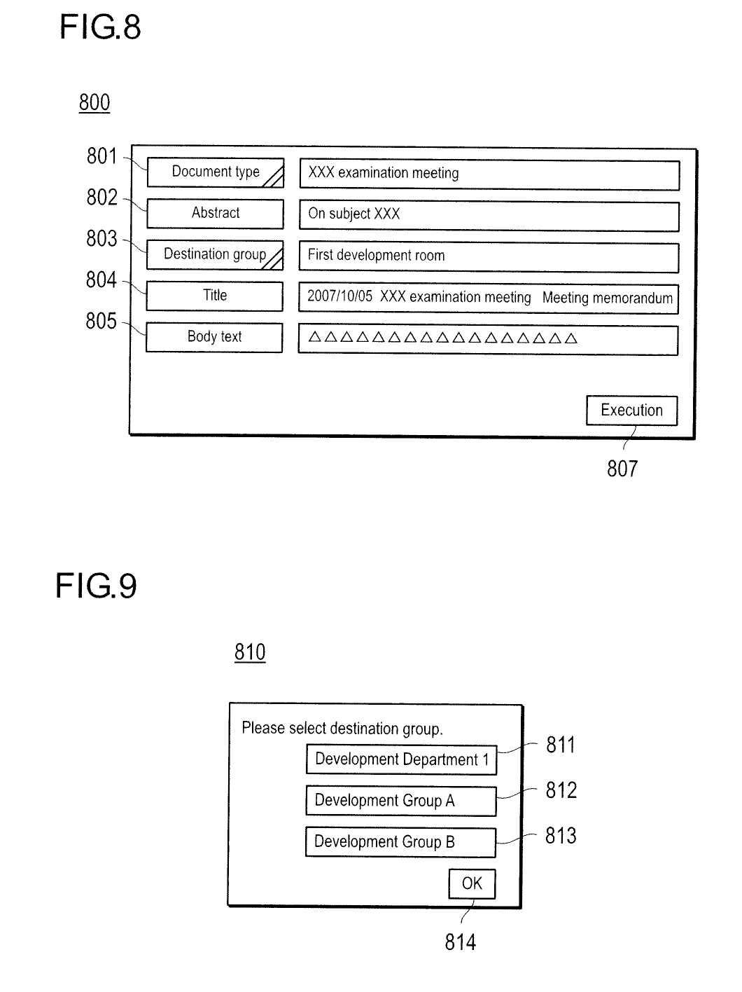

FIG. 8 is a diagram showing an example of a additional information designating screen. The user selects or designates about designating items 801-805 on the additional information designating screen 800 displayed on the operating panel 105 of the MFP 100 before executing the scanning of a document image. The additional information designating screen 800 is equipped with a document type designating unit 801, a summary designating unit 802, a destination group designating unit 803, a title designating unit 804, a body text designating unit 805, and an execution button 807. These setup items are only examples, and the setup items to be managed can be increased.

The document type designating unit 801 is used to designate type information (document theme ID) for indicating the contents of the file (specific file) of the image data acquired by scanning document image. The summary designating unit 802 is used for designating the bookmark information as the identification information for identifying a specific file. The destination group designating unit 803 is used for designating the destination of notification mail. The title destination designating unit 804 is used for designating the title of notification mail. The body text designating unit 805 is used for designating the body text of notification mail. The execution button 807 is used to start scanning the document image.

The destination group designating unit 803 constitutes a selection button for receiving the user's selection. When the address group designating unit (selection button) 803 is depressed, the address group selection screen 810 is displayed.

FIG. 9 is a diagram showing an example of the user selection screen. When the user selects one of the items 811-813 displayed on the destination group selection screen 810 and depresses the OK button, the item selected in the destination group designating unit 803 of the additional information designating screen 800 is reflected (see FIG. 8). The document type designating unit 801 also constitutes a selection button for receiving the user's selection, and the document types selection screen similar to the address group selection screen 810 is displayed to receive the user's selection.

In other words, when the document type designating unit 801 or the destination group designating unit 803 (selection button) is depressed, the MFP 100 transmits to the coordination application server 200 a selection screen data request for acquiring the selection screen data which is the data for either the document type selection screen or the destination group selection screen (S9). Next, the coordinated application server 200 prepares the selection screen data corresponding with the request (S10). For example, when the selection screen data request of acquiring the selection screen data, which is the destination group selection screen, is received, the coordination application server 200 inquires the database server 400 about it.

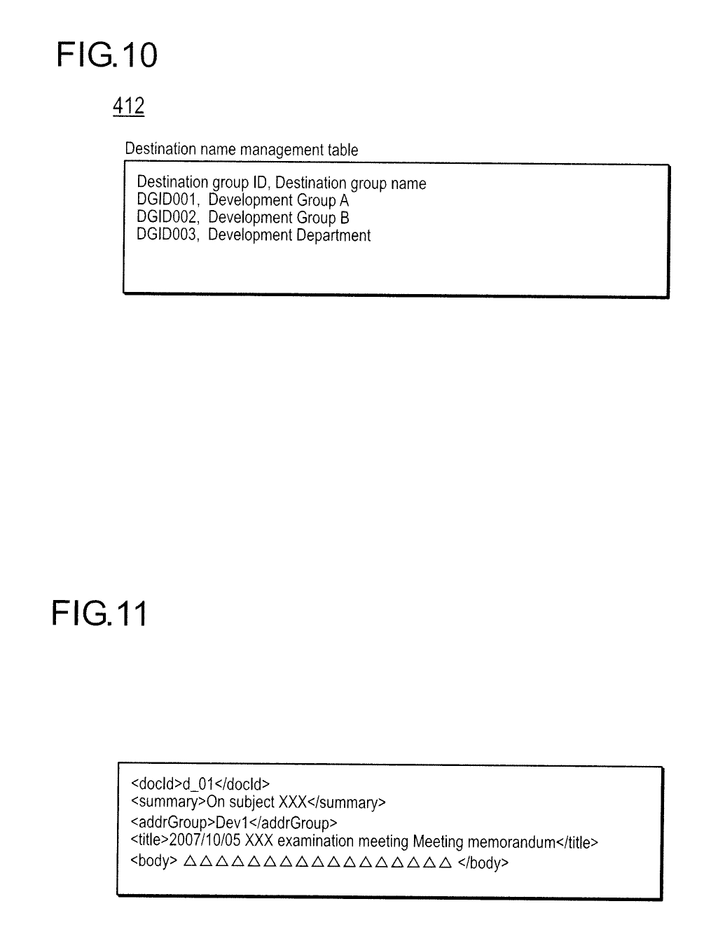

FIG. 10 is a diagram showing an example of the destination name management table, which is one of the data-table 401 stored in the data base server 400. A destination name management table 412 shown in FIG. 10 contains the ID of the destination group and the destination group name that corresponds with the particular ID. The coordinated application server 200 of the present embodiment prepares the selection screen data based on the information of the destination name management table 412 shown in FIG. 10.

The coordinated screen server 200 provides a response to the selection screen data request to the MFP 100 (S11). In other words, the coordinated application server 200 transmits the selection screen data to the MFP 100. The MFP 100 displays the selection screen on the operating panel 105 based on the received selection screen data (S12). Next, when one of the items is selected from the selection screen displayed on the operating panel 105 (S13), the control returns to the initial screen of the additional information designating screen 800 (S14), and the selected item is reflected.

FIG. 11 is a diagram showing an example of the additional information file. The additional information file of the additional information as shown in FIG. 11 is prepared based on the additional information received using the additional information designating screen 800 shown in FIG. 8. The additional information file in this example is XML data. The tag name of XML data when describing a file for additional information corresponds with the designating items 801-805 of the additional information designating screen 800, and is designated as shown in FIG. 11. In FIG. 11, [docId] corresponds with the document type designating unit 801, [summary] corresponds with the summary designating unit 802, [addrGroup] corresponds with the destination group designating unit 803, [title] corresponds with the title designating unit 804, and [body] corresponds with the body text designation unit 805.

Next, the operations of the file storage system of the present embodiment will be described.

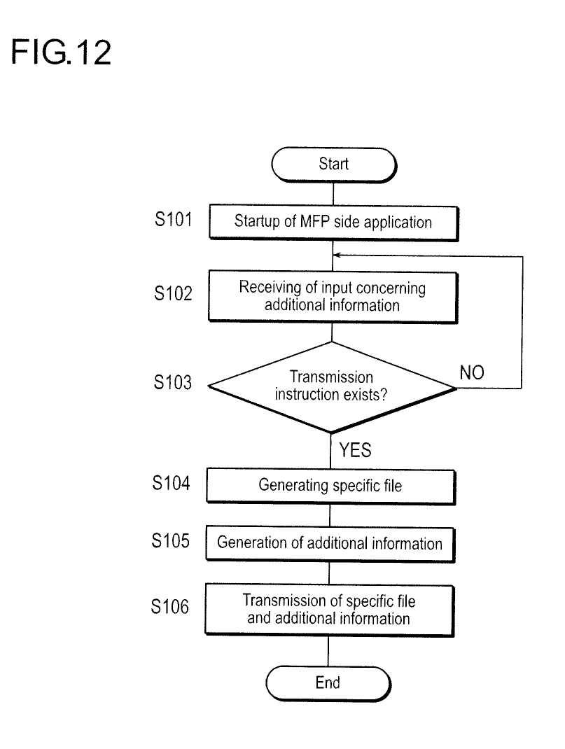

FIG. 12 is a flowchart showing the procedure of data transmission process of specific files and additional information on the MFP 100. The algorithm indicated by the flowchart of FIG. 12 is stored as a program in a storage unit such as hard disk 104 of MFP 100, and the particular program is read out by RAM 103, and executed by CPU 101.

When the MFP side application of the MFP 100 is activated by the user's operation (S101), the MFP 100 displays the additional information designating screen 800 on the operating panel 105 (see FIG. 8), and receives the user's input concerning the additional information as described before (S102).

Next, a judgment is made as to whether or not there was any instruction for transmitting the image data file acquired by scanning the document image (S103). More specifically, a judgment is made as to whether or not the execution button 807 of the additional information designating screen 800 is depressed.

If it is judged that there is no instruction for transmitting the file (S103: No), the program returns to step S102.

On the other hand, if there was an instruction for transmitting the file (S103: Yes), the document image is scanned and the file of the acquired image data is generated as the specific file (S104).

Next, additional information is generated based on the user's input received via the additional information designating screen 800 (S105).

The MFP 100 transmits the generated specific file and the additional information to the FTP server 300 (S105). The specific file and additional information transmitted to the FTP server 300 are stored in the designated directory in the data storage area 301 of the FTP server 300.

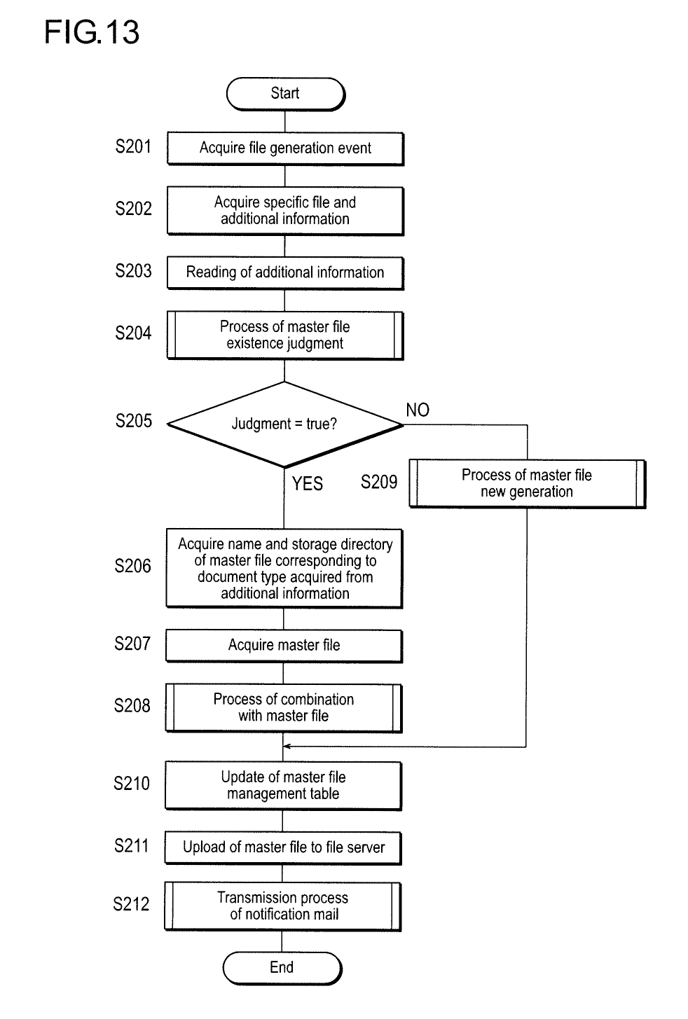

FIG. 13 is a flow chart showing the procedure of file storage process on the coordination application server 200. The algorithm indicated by the flowchart of FIG. 13 is stored as a program in a storage unit such as the hard disk 204 of the coordinated application server 200, and the particular program is read out on the RAM 203, and executed by the CPU 201.

The flow chart shown in FIG. 13 describes the process flow in the coordinated application server 200 immediately after the specific file and additional information acquired by scanning the document image are transmitted to the FTP server 300 until the notification mail notifying that the master file is updated or added.

As a file generation event indicating that a file is generated in the designated directory of the FTP server 300 is received by the file generation event monitoring unit 215 (S201), the coordinated application server 200 acquires the specific file and additional information from the FTP server 300 (S202).

Next, the contents of the acquired additional information is read out (S203) The additional information is stored in the data storage area 219 at this point.

Then, the master file existence judgment process is executed (S204). In the master file existence judgment process, a judgment is made as to whether or not a master file corresponding to the type information indicating the type of contents of specific file exists in the file server 500. The details of such a master file existence judgment process will be described later.

If the judgment result acquired in the master file existence judgment process is “true,” in other words, if the master file already exists in the file server 500 (S205: Yes), the coordinated application server 200 transmits an inquiry to the data server 400 about and acquires the name and storage location information of the master file corresponding to the document type acquired from the additional information (S206).

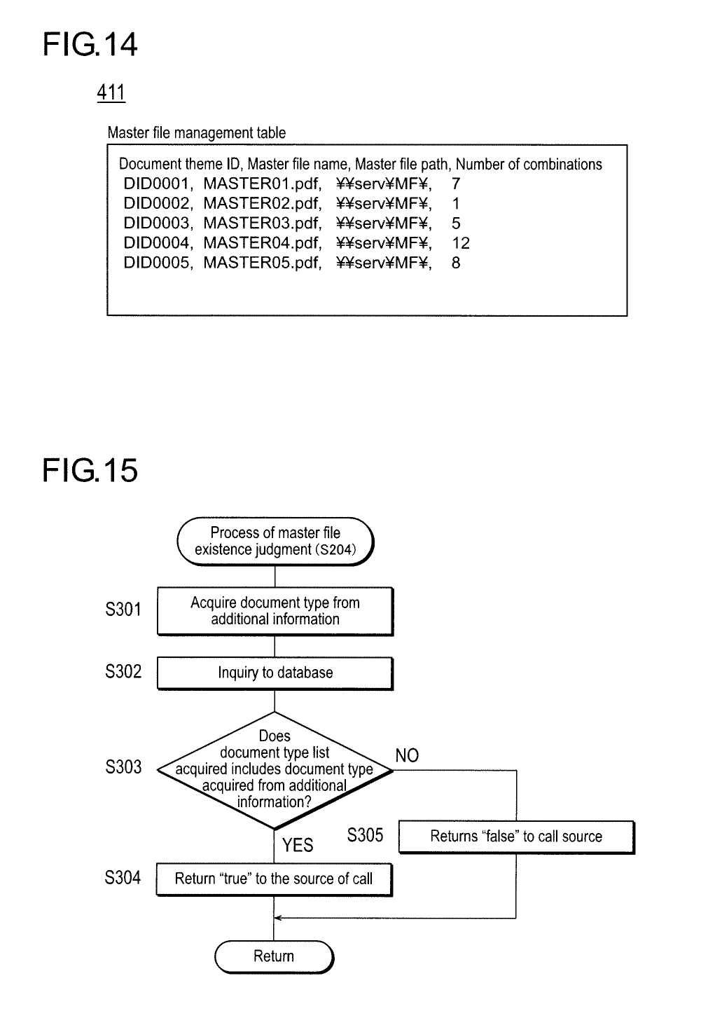

FIG. 14 is a diagram showing an example of the master file management table, which is one of the data-table 401 stored in the data base server 400. The master file management table 411 shown in FIG. 14 contains a document theme ID corresponding to each document type, the master file's name, the master file's storage location information (path information), and number of the special file's combinations (postscripts) to the master file.

Next, the coordination application server 200 acquires the corresponding master file from the file server 500 (S207), and executes the combination process of the specific file to the master file (S208). The details of such a master file combination process will be described later.

On the other hand, if the result of the master file existence judgment process is not “true,” i.e., the master file does not exist in the file server 500 (S205: No), the coordinated application server 200 executes the new generation process of the master file (S209). The details of such a master file new generation process will be described later.

Next, the coordinated application server 200 transmits the information concerning the update or addition of the master file to the database server 400, and updates the master file management table 411 of the database server 400.

The coordinated application server 200 uploads the latest master file acquired by combination or new generation onto the file server 500 (S211).

The coordinated application server 200 transmits notification mail notifying that the master file is updated or added to the designated destination (S212). The detail of transmission process for such a notification mail will be discussed later.

FIG. 15 is a flowchart showing the sequence of the master file existence judgment process (S204).

The coordination server 200 first acquires the document type indicating the type of the contents of the specific file from the additional information acquired simultaneously with the specific file and identifies it (S301).

Next, the coordinated application server 200 transmits an inquiry to the database server 400 and acquires the master file management table 411 from the database server 400 (S302).

In step S303, the coordinated application server 200 makes a judgment as to whether or not the document type which is acquired from the additional information and recognized is included in the list of document type (document theme ID) of the master file management table 411 (S303).

The coordinated application server 200 then returns a message “true (exists)” to the source of call of this process (304) if the document type which is acquired from the additional information is included in the list of document types (S303: Yes), or returns a message “false (not included)” (S305) if the document type which is acquired from the additional information is not included in the list of document types (S303: No).

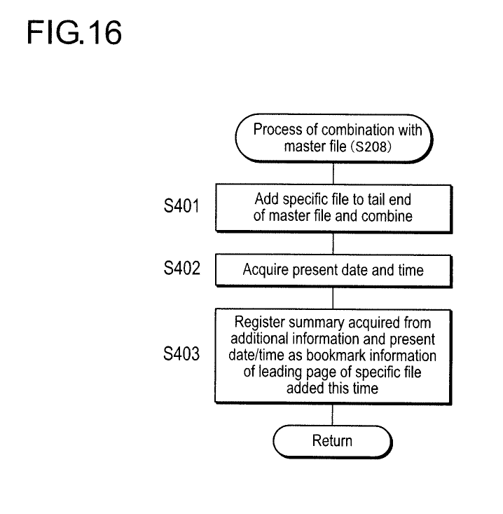

FIG. 16 is a flowchart showing the sequence of the master file combination process (S208). The flowchart shown in FIG. 16 describes the flow of the process of combining the specific file to the master file.

According to the published specification of PDF, the coordination application server 200 adds and combines the specific file acquired by scanning the document image this time to the tail end of the master file acquired in step S207 (S401).

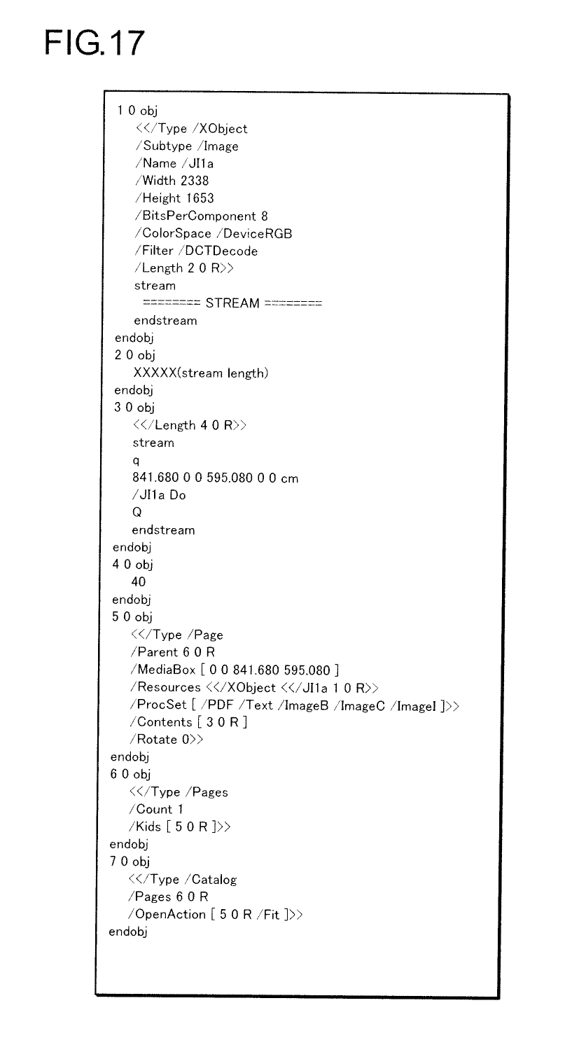

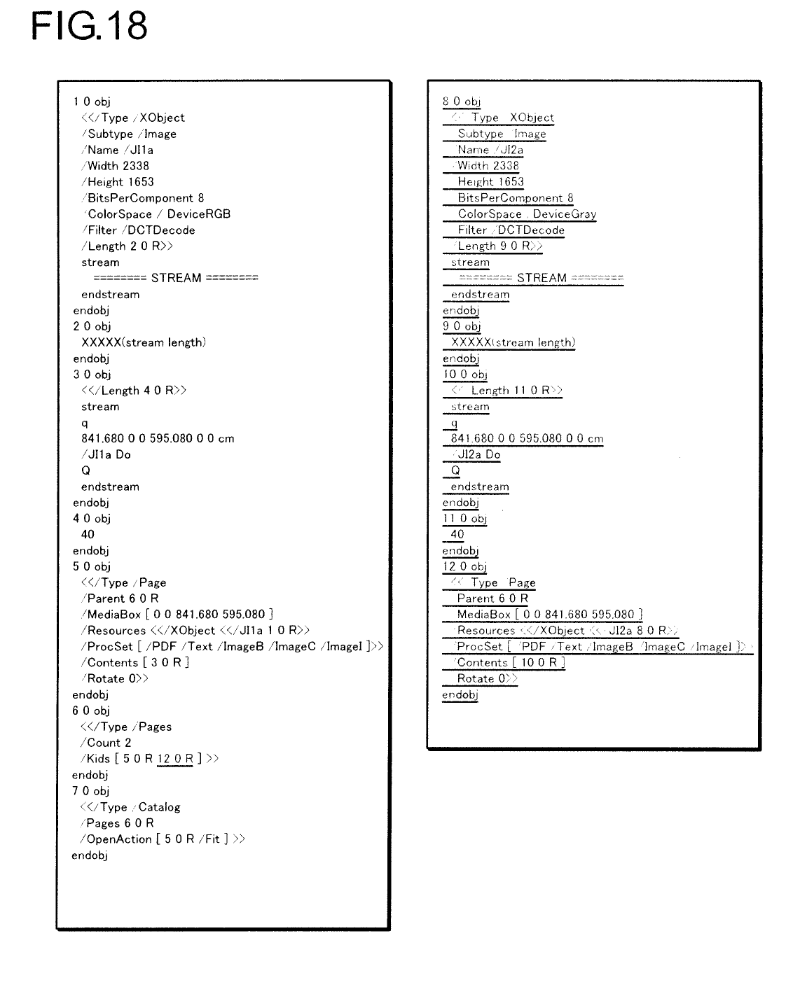

FIG. 17 is a diagram showing an example of the master file prior to the combining of a specific file, and FIG. 18 is a diagram showing an example of the master file after the combination of a specific file. In FIG. 18, the description for adding a page of the specific file is indicated with an underline for ease of understanding.

Next, the present date and time are acquired (S402).

The coordinated application server 200 further registers, in accordance with the specification of PDF, the summary information acquired from the additional information as well as the date and time acquired in step S402 to the master file as the bookmark information at the leading page of the specific file which was added this time (S403).

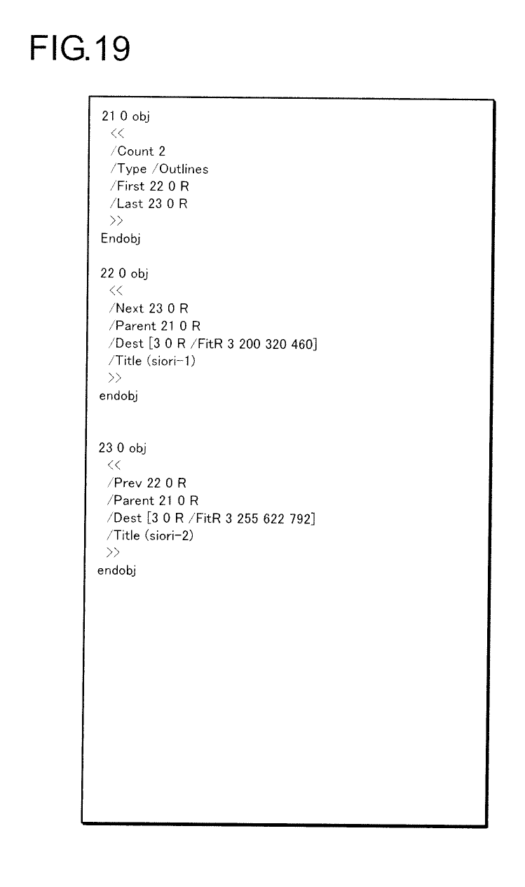

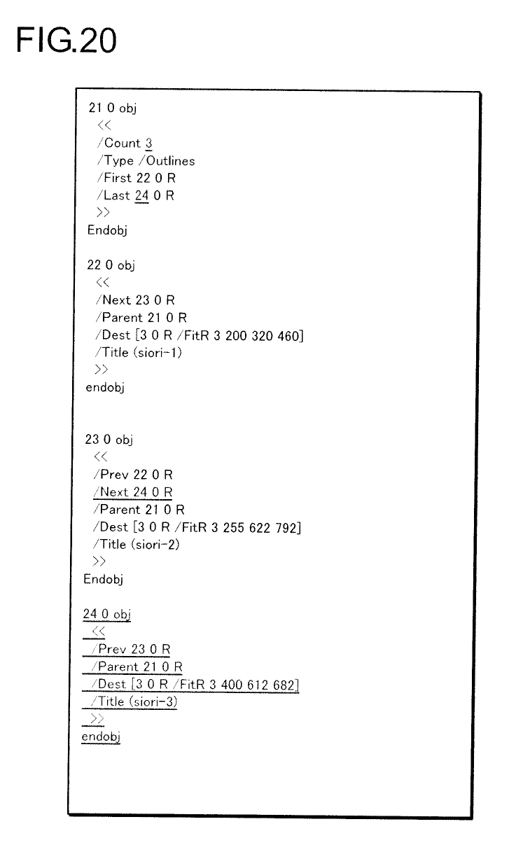

FIG. 19 shows an example of bookmark information, and FIG. 20 is a diagram showing an example of bookmark information after new bookmark information is added. In FIG. 20, the description for adding new bookmark information is indicated with an underline for ease of understanding. In FIG. 20, the description of the portion of “siori-3” is indicated as “bookmark” when the master file is displayed. As shown above, summary information and identification information such as date and time can be set up as the bookmark information to the master file, which is a PDF file, using the outline function of the PDF specification. If in case bookmark information needs to be added anew, the outline object shown in FIG. 19 needs to be described.

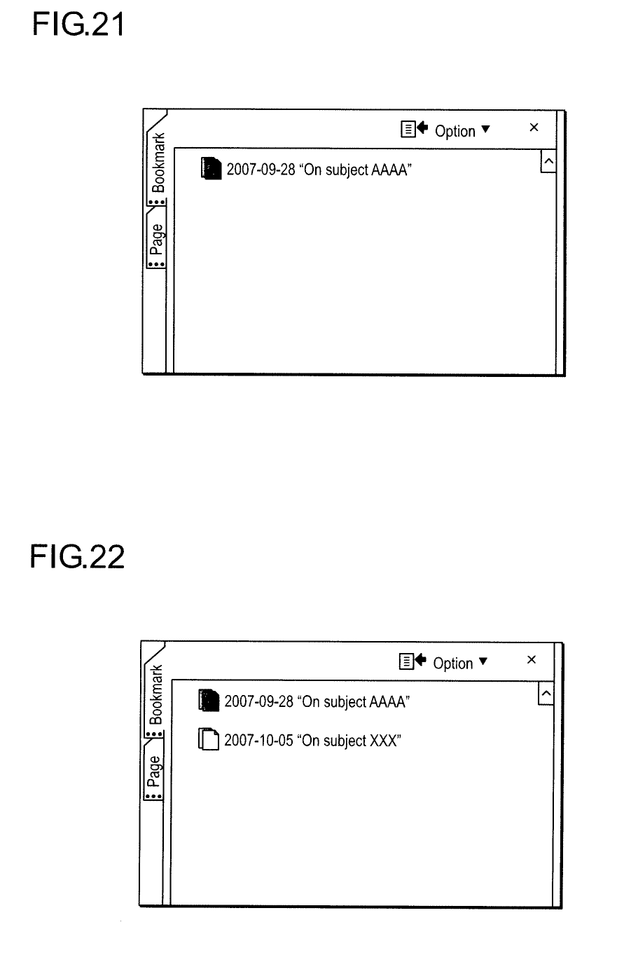

FIG. 21 is a diagram showing an example of “bookmark” for displaying the master file prior to adding new bookmark information, and FIG. 22 is a diagram showing an example of “bookmark” for displaying the master file after adding new bookmark information. FIG. 22 shows that the date/time information (date only in this case) and the summary information acquired from the additional information are added as “bookmark” to the master file shown in FIG. 21.

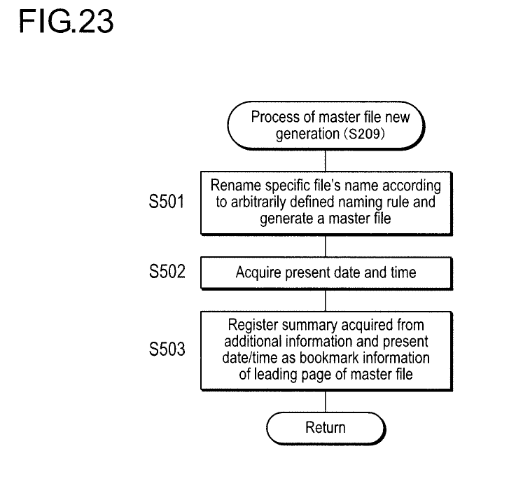

FIG. 23 is a flowchart showing the sequence of the master file new generation process (S209). The flowchart of FIG. 23 shows the process to be implemented when it is judged that the master file does not exist in the master file existence judgment process (S204).

The coordinated application server 200 renames the name of the specific file acquired from the FTP server 300 in accordance with the naming rule arbitrarily specified and generates a master file (S501).

Next, the present date and time are acquired (S502)

The coordinated application server 200 further registers, in accordance with the specification of PDF, the summary information acquired from the additional information as well as the date and time acquired in step S502 to the particular master file as the bookmark information at the leading page of the specific file, i.e., the master file in this case (S503). The method of adding the bookmark information is the same as described in FIG. 16.

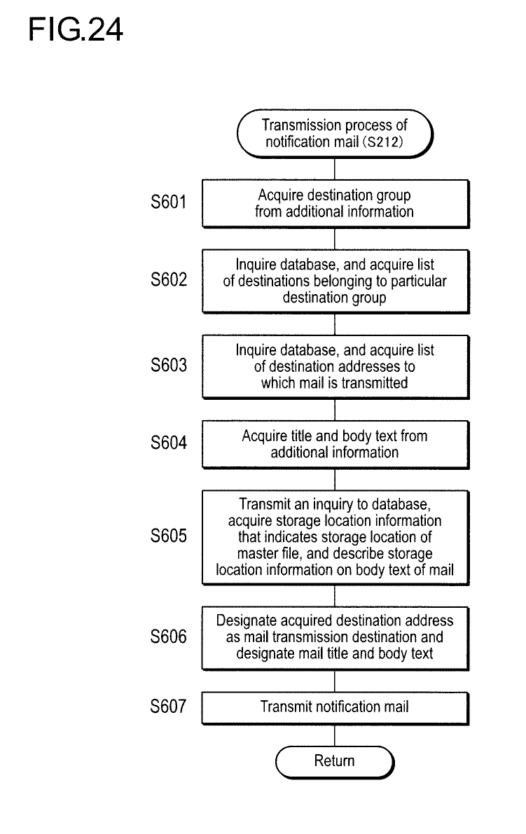

FIG. 24 is a flowchart showing the sequence of the transmission process for the notification mail (S212). The flowchart shown in FIG. 24 describes the process flow for notifying that the master file is updated or added using the acquired additional information.

First, the coordinated application server 200 acquires the information about the destination group from the additional information (S601).

Next, the coordinated application server 200 transmits an inquiry to the database server 400 and acquires the list of destinations belonging to the particular destination group (S602).

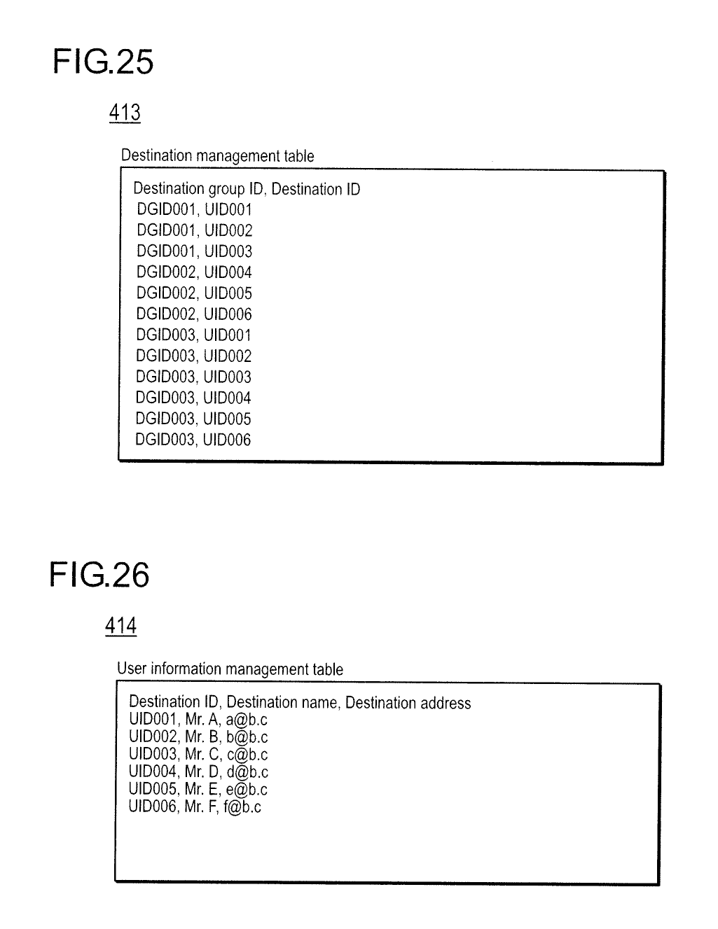

FIG. 25 is a diagram showing an example of the destination management table, which is one of the data-table 401 stored in the data base server 400. The destination name management table 413 shown in FIG. 25 contains the ID of the destination group and the ID of the destinations that belong to the particular destination group. In other words, the list of ID of the destinations is acquired in step S602.

Next, the coordinated application server 200 transmits an inquiry to the database server 400 and acquires the list of the destinations to which the information is actually sent (S603).

FIG. 26 is a diagram showing an example of the user information management table, which is one of the data-table 401 stored in the data base server 400. A user information management table 414 shown in FIG. 26 contains the destination ID, destination name and destination address. In other words, a list of destination addresses to which the information is actually sent referencing the user information management table 414 from the destination ID list acquired in step S602.

Next, the coordinated application server 200 acquires the information about the title and body text from the additional information (S604). Any one of steps S601-S603 and S604 can be executed first.

Next, the coordinated application server 200 transmits an inquiry to the database server 400, acquires the master file storage location information, and described the storage location information in the body text of notification email (S605). The storage location information of the master file can be acquired from the master file management table 411.

Next, the coordinated application server 200 designates the destination addresses acquired in step S603 as the destinations of the notification mail and designates the title and body text acquired in step S604 as the title and body text of the notification mail (S606).

Then, the coordinated application server 200 transmits the prepared notification mail (607).

As can be seen above, in the present embodiment, the coordinated application server 200 acquires the specific file and the additional information concerning the specific file to be stored, identifies the document type, which is the type information indicating the type of contents of the specific file from the additional information, and makes a judgment as to whether or not the master file corresponding to the document type exists in the file server 500. If it is determined that a master file that correspond to the designated document type, the coordinated application server 200 combines the specific file with the master file, and adds the date/time information and the summary information, which is the identification information, for identifying the specific file, identified from the additional information, to the master file as the bookmark information, which is the reference information for referencing the specific file in the master file.

Therefore, according to the present embodiment, the number of files to be managed reduces, thus alleviating the user's toil and making the access easier since the specific file to be stored is combined with the master file corresponding to the document type. Moreover, since the identification information acquired from the additional information is added as the bookmark information in order to reference the specific file among the master file, it is possible to identify each specific file as in the table of contents and easily grasp the contents of the master file combined with the specific file. In other words, the present embodiment makes it easier for the user to grasp the contents of stored files, thus enhancing the accessibility.

Next, the second embodiment of the invention will be described below. In the following paragraphs, only the differences from the abovementioned first embodiment will be described, omitting the descriptions on points that are identical to those in the first embodiment.

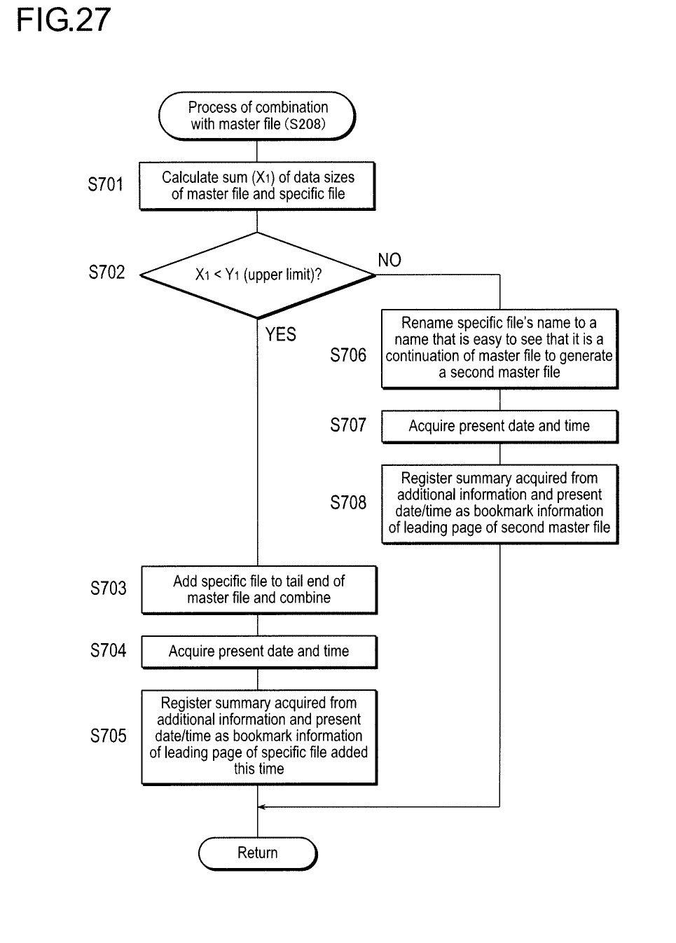

FIG. 27 is a flowchart showing the process sequence of the master file combination process (S208) according to the second embodiment of the invention.

The flowchart shown in FIG. 27 describes a process flow in which, after specifying first an upper limit for the data size of the master file, a specific file is combined to a master file if the data size of the master file after combination of the specific file is smaller than the upper limit, or a new master file is automatically prepared without combining the specific file if said data is larger than the upper limit. Let us assume that the upper limit of the data size is 100 Mbyte.

First, the coordinated application server 200 calculates the sum (X₁) of the data size of the master file acquired in step S207 and the data size of a specific file acquired in step S202 (S701).

Next, a judgment is made as to whether or not the sum (X₁) of the data size of the master file and the data size of a specific file is smaller than the upper limit (Y₁=100 Mbyte) (S702).

If it is judged that X₁<Y₁ (S702: Yes), the coordinated application server 200 combines the specific file acquired by scanning the document image this time to the tail end of the master file (S703).

Next, the present date and time are acquired (S704)

The coordinated application server 200 further registers the summary information acquired from the additional information as well as the date and time acquired in step S704 to the master file as the bookmark information at the leading page of the specific file which was added this time (S705).

If, on the other hand, it is judged that X₁≧Y₁ (S702: No), the coordinated application server 200 renames the name of the specific file acquired from the FTP server 300 to another name which makes it easier to identify that it is the continuation of the master file acquired in step S207 (e.g., maser file's name+“2”) to generate a second master file (S706).

Next, the present date and time are acquired (S707).

The coordinated application server 200 further registers the summary information acquired from the additional information as well as the date and time acquired in step S707 to the second master file as the bookmark information at the leading page of the particular second master file (S708).

As can be seen from the above, the second embodiment not only provides similar effects as in the first embodiment, but also prevents the data size of each master file from becoming too large.

Next, the third embodiment of the invention will be described below. In the following paragraphs, only the differences from the abovementioned first embodiment will be described, omitting the descriptions on points that are identical to those in the first embodiment.

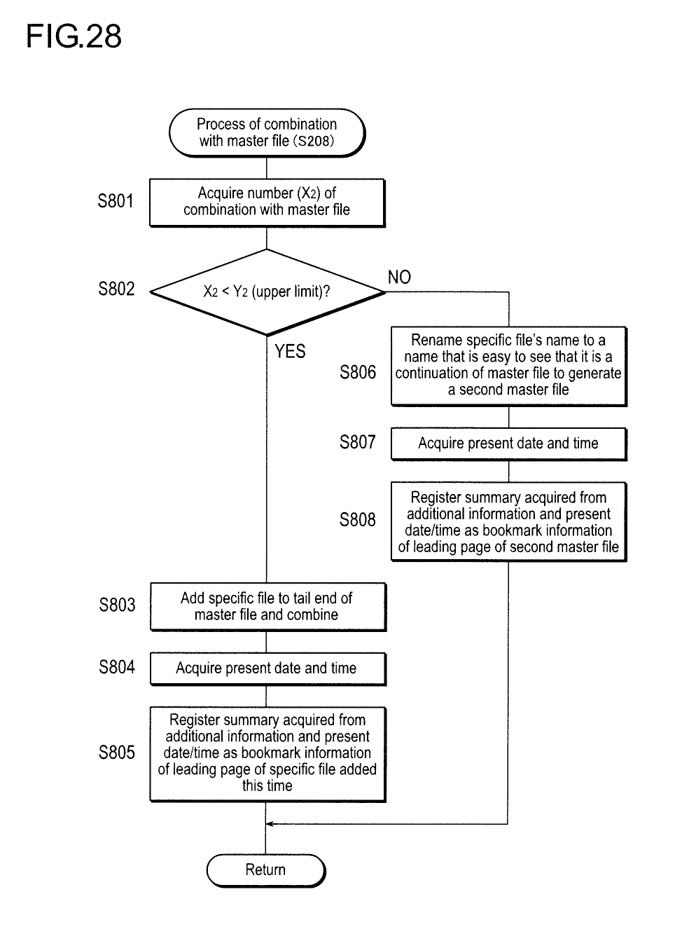

FIG. 28 is a flowchart showing the process sequence of the master file combination process (S208) according to the third embodiment of the invention.

The flowchart shown in FIG. 28 describes the process flow in deciding whether to combine the specific file to the master file or to prepare a new master file depending on the number of combinations of the specific file to the master file described in the master file management table 411 stored in the database server 400 (see FIG. 14). Let us assume that the upper limit of the number of combinations is 10.

First, the coordinated application server 200 transmits an inquiry to the database using the document type (document theme ID) acquired from the additional information as the key, and acquires the number of combinations (X₂) of the specific file to the particular master file (S801). If the information of the master file management table 411 is already acquired and stored in the master file existence judgment process (S204), the stored information can be used as well.

Next, a judgment is made as to whether or not the number of combinations (X₂) of the specific file to the master file is smaller than the upper limit (Y₂=10 times) (S802).

If it is judged that X₂<Y₂ (S802: Yes), the program advances to the step S803. If it is judged that X₂≧Y₂ (S802: No), the program advances to the step S806.

Since the steps S803 through S808 are identical to the steps S703 through S708 shown in FIG. 27, their descriptions are omitted.

As can be seen from the above, the third embodiment not only provides similar effects as in the first embodiment, but also prevents the data size of each master file from becoming too large similar to the second embodiment.

Next, the fourth embodiment of the invention will be described below. In the following paragraphs, only the differences from the abovementioned first embodiment will be described, omitting the descriptions on points that are identical to those in the first embodiment.

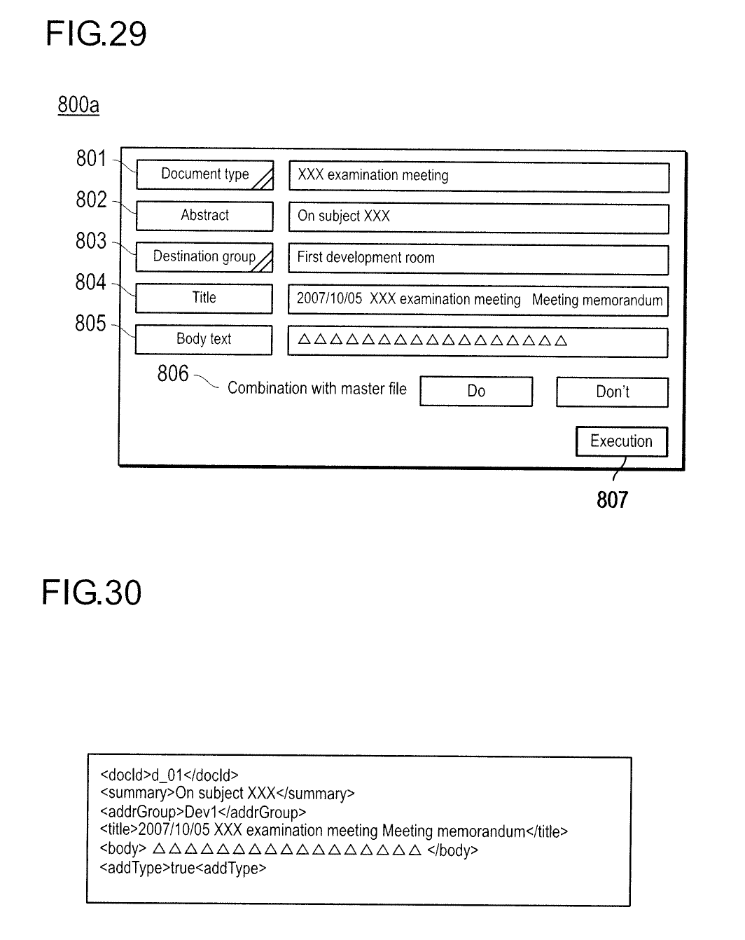

FIG. 29 is an example of the additional information setup screen according to the fourth embodiment.

The additional information designating screen 800a shown in FIG. 29 has a document type designating unit 801, a summary designating unit 802, a destination group designating unit 803, a title designating unit 804, a body text designating unit 805, and an execution button 807 for starting the scanning of the document image, as well as a combination designating unit 806. The combination designating unit 806 is used for designating whether to combine the specific file to the master file or not.

FIG. 30 is an example of the additional information file according to the fourth embodiment. The additional information file of the additional information as shown in FIG. 11 is prepared based on the additional information received using the additional information setup screen 800a shown in FIG. 29. In FIG. 30, [addType] corresponds to the combination designating unit 806. When the button for combining is depressed in the combination designating unit 806 shown in FIG. 29, [true] is described in [addType] of FIG. 30.

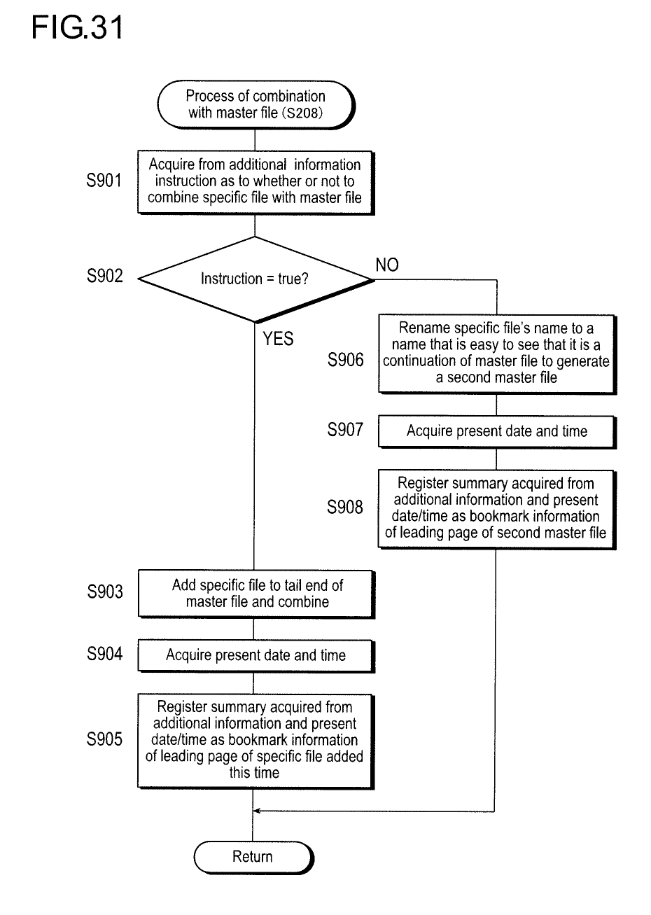

FIG. 31 is a flowchart showing the process sequence of the master file combination process (S208) according to the fourth embodiment of the invention.

The flowchart shown in FIG. 31 indicates the flow of process when the user instructs whether or not to combine the specific file to the master file on the additional information designating screen 800a displayed on the operation panel unit 105 of the MFP 100.

First, the coordinated application server 200 acquires from the additional information the Instruction whether or not to combined the specific file to the master file (S901).

If there is an instruction to combine the specific file to the master file, i.e., if “true” is written in [addType] of the additional information (S902: Yes), the program advances to the step S903. If there is an instruction not to combine the specific file to the master file, i.e., if “false” is written in [addType] of the additional information (S902: No), the program advances to the step S906.

Since the steps S903 through S908 are identical to the steps S703 through S708 shown in FIG. 27, their descriptions are omitted.

As can be seen from the above, the fourth embodiment not only provides similar effects as in the first embodiment, but also prevents the data size of each master file from becoming too large similar to the second embodiment.

It is obvious that this invention is not limited to the particular embodiments shown and described above but may be variously changed and modified without departing from the technical concept of this invention.

For example, the present invention is not limited to the equipment constitution exactly as shown in FIG. 1 and can vary in accordance with the system operation scale. In other words, at least two or more of the coordinated application server 200, FTP server 300, database server 400, and file server 500 can be replaced by one or two PCs. Also, the MFP 100 can have at least one or more of the functions of the coordinated application server 200, FTP server 300, database server 400, and file server 500. As can be seen from the above, the master file combination device, master file storage device, file transmission device, and specific file storage device can be borne by either one of the MFP 100, coordinated application server 200, FTP server 300, database server 400, and file server 500. Also, the function of each of these devices can be provided on either of the MFP 100, coordinated application server 200, FTP server 300, database server 400, and file server 500.

Although an example of registering the summary as the bookmark information in the abovementioned embodiments, the present invention is not limited to it. The present invention can use arbitrary identification information for identifying a specific file such as the name of the person who generated it and the date/time it is generated as the bookmark information.

Although the abovementioned embodiments show an example where the master file is a PDF file and the reference information for referencing the specific file in the master file is the bookmark designated in the PDF file, the present invention is not limited to it. The present invention can use a file of arbitrary format as the master file so long as it has a function for combining files and is also a file to which reference information such as table of contents information for referencing a specific page among a file can be registered.

Moreover, although it was described in the abovementioned embodiments that the specific file stored in the FTP server 300 is a file of the image data acquired by scanning the document image by the MFP 100, the present invention is not limited to it. In the present invention, the specific file to be sent to the FTP server 300 can be an arbitrary file that can be sent to the FTP server 300 such as a document file prepared in the user's PC 600. In this case, the user's PC 600 uploads the prepared document file and the additional information concerning the particular document file to the designated directory of the FTP server 300.

The means and method of conducting various processes in the file storage system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the device as a part of its function.

What is claimed is:

1. A file storing method comprising:
(a) a master file combination device acquiring a specific file to be stored and additional information concerning the specific file;
(b) said master file combination device identifying type information that indicates a type of contents of said specific file from said additional information;
(c) said master file combination device judging whether or not a master file that corresponds to said type information exists in a master file storage device; and
(d) said master file combination device combining said specific file with said master file and adding identification information, for identifying said specific file, identified from said additional information to said master file as reference information for referencing said specific file in said master file, if it is judged that a master file that corresponds to said type information exists.

2. The file storing method as claimed in claim 1, further comprising:
(e) said master file combination device transmitting notification mail containing storage location information for designating storage place of said master file with which said specific file is combined to a designated destination.

3. The file storing method as claimed in claim 1, further comprising:
(f) a file transmission device generating a specific file to be generated;
(g) said file transmission device generating additional information concerning said specific file; and
(h) said file transmission device transmitting said specific file and said additional information in order to cause said specific file and said additional information to be stored in a specific file storage device, wherein
in said step (a), said master file combination device acquires said specific file and said additional information from said specific file storage device.

4. The file storing method as claimed in claim 3, wherein
in said step (f), said file transmission device generates said specific file by reading a document image.

5. The file storing method as claimed in claim 3, wherein said step (g) comprises:
(g1) said file transmission device displaying on a display unit an additional information designating screen for designating additional information concerning said specific file based on user's operation;
(g2) said file transmission device receiving the user's input via said additional information designating screen; and
(g3) said file transmission device generating said additional information based on said user's input.

6. The file storing method as claimed in claim 5, further comprising:
(i) said master file combination device transmitting said additional information designating screen's in formation to said file transmission device.

7. The file storing method as claimed in claim 6, further comprising:
(j) said file transmission device requesting said master file combination device said additional information designating screen's information based on the user's operation, wherein
in said step (i), said master file combination device transmits said additional information designating screen's information to said file transmission device in response to said request in said step (j).

8. The file storing method as claimed in claim 1, wherein
in said step (c), said master file combination device makes a judgment as to whether or not type information that indicates the type of contents of said specific file exists in a type information list where type information is stored for indicating a type of the contents of each master file stored in said master file storage device.

9. The file storing method as claimed in claim 1, wherein
said master file is a PDF file and said reference information is bookmark information designated in the PDF file.

10. The file storing method as claimed in claim 2, wherein
said additional information contains a title or a body text based on the user's input, and
in said step (e), said master file combination device transmits said notification mail containing said title or body text in addition to said storage location information to a designated destination.

11. The file storing method as claimed in claim 2, wherein
said additional information contains a destination group based on the user's input, and
in said step (e), said master file combination device acquires destinations that belong to a destination group contained in said additional information from a destination list storing destinations that belong to each destination group, and transmits said notification mail to the particular destinations.

12. The file storing method as claimed in claim 1, wherein
in said step (d), if said master file's data size exceeds a specified upper limit when said specific file is combined with said master file, said master file combination device treats said specific file as the second master file that is equivalent to a continuation of said master file, and adds identification information, for identifying said specific file, identified from said additional information to said second master file as reference information for referencing said specific file in said second master file.

13. The file storing method as claimed in claim 1, wherein
in said step (d), if the number of combinations with said master file exceeds a specified upper limit when said specific file is combined with said master file, said master file combination device treats said specific file as the second master file that is equivalent to a continuation of said master file, and adds identification information, for identifying said specific file, identified from said additional information to said second master file as reference information for referencing said specific file in said second master file.

14. The file storing method as claimed in claim 1, wherein
in said step (d), if the user's instruction not to combine said specific file with said mater file already exists in said additional information, said master file combination device treats said specific file as the second master file that is equivalent to a continuation of said master file, and adds identification information for identifying said specific file identified from said additional information to said second master file as reference information for referencing said specific file in said second master file.

15. A file storage system comprising:
a specific file generating unit for generating a specific file to be stored;
an additional information generating unit for generating additional information concerning said specific file;
a specific file storage unit for storing said specific file and said additional information;
a master file storage unit for storing a master file with which said specific file can be combined;
an acquiring unit for acquiring said specific file and said additional information from said specific file storage unit:
an identification unit for identifying type information that indicates a type of contents of said specific file from said additional information;
a judgment unit for judging whether or not a master file that corresponds to said type information exists in said master file storage unit; and
a combination processing unit for combining said specific file with said master file and adding identification information, for identifying said specific file, identified from said additional information to said master file as reference information for referencing said specific file in said master file, if it is judged that a master file that corresponds to said type information exists.

16. The file storage system as claimed in claim 15, further comprising:
a notification processing unit for transmitting notification mail containing storage location information for designating storage place of said master file with which said specific file is combined to a designated destination.

17. A computer readable recording medium stored with a computer program executable on a mater file combination device for combining files, said computer program causing said master file combination device to execute a process comprising:
(a) acquiring a specific file to be stored and additional information concerning the specific file;
(b) identifying type information that indicates a type of contents of said specific file from said additional information;
(c) judging whether or not a master file that corresponds to said type information exists in a master file storage device; and
(d) combining said specific file with said master file and adding identification information, for identifying said specific file, identified from said additional information to said master file as reference information for referencing said specific file in said master file, if it is judged that a master file that corresponds to said type information exists.

18. The computer readable recording medium as claimed in claim 17, wherein
said process further comprises:
(e) transmitting notification mail containing storage location information for designating storage place of said master file with which said specific file is combined to a designated destination.
